(19) United States
(12) Patent Application Publication
(10) Pub. No.: US 2013/0226670 A1
(43) Pub. Date: Aug. 29, 2013

(54) METHOD AND SYSTEM FOR AUTOMATICALLY PARTITIONING AND PROCESSING A BUSINESS PROCESS

(71) Applicants: Andres Quiroz Hernandez, Rochester, NY (US); Ramses V. Morales, Sunnyvale, CA (US); Hua Liu, Fairport, NY (US)

(72) Inventors: Andres Quiroz Hernandez, Rochester, NY (US); Ramses V. Morales, Sunnyvale, CA (US); Hua Liu, Fairport, NY (US)

(73) Assignee: XEROX CORPORATION, Norwalk, CT (US)

(21) Appl. No.: 13/403,440

(22) Filed: Feb. 23, 2012

(51) Int. Cl. G06Q 10/06

(52) U.S. Cl. 705/7.36

(57) ABSTRACT

A method of implementing a business process may include receiving business process information associated with a business process. The business process information may include a graph representing one or more activities to be performed to complete the business process. The method may include identifying, by a computing device, a number of groups associated with the business process information. Each group may be capable of performing at least a portion of the activities. The method may include partitioning, by the computing device, the graph into a number of fragments that is greater than or equal to the number of identified groups. Each fragment may include one or more activities from the graph. The method may include, for each fragment, transmitting the fragment to an identified group that is capable of performing each activity associated with the fragment, and orchestrating the performance of the activities associated with each fragment by each group.

### BACKGROUND

Business process engines typically execute business process scripts by instantiating a business process definition and orchestrating the execution of each activity contained within the business process. Execution involves marshalling and linking inputs and outputs of the different activities. A business process engine is usually centralized, but the execution of activities can be distributed. Alternatively, multiple business process engines interact to execute collaborating business processes, but each business process must be defined manually as separate business process scripts.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In an embodiment, a method of implementing a business process may include receiving business process information associated with a business process. The business process information may include a graph representing one or more activities to be performed to complete the business process. The method may include identifying, by a computing device, a number of groups associated with the business process information. Each group may be capable of performing at least a portion of the activities. The method may include partitioning, by the computing device, the graph into a number of fragments that is greater than or equal to the number of identified groups. Each fragment may include one or more activities from the graph. The method may include, for each fragment, transmitting the fragment to an identified group that is capable of performing each activity associated with the fragment, and orchestrating the performance of the activities associated with each fragment by each group.

A system for implementing a business process may include a computing device and a computer-readable storage medium in communication with the computing device. The computer-readable storage medium may include one or more programming instructions that, when executed, cause the computing device to receive business process information associated with a business process. The business process information may include a graph representing one or more activities to be performed to complete the business process. The computer-readable storage medium may include one or more programming instructions that, when executed, cause the computing device to identify a number of groups associated with the business process information. Each group may be capable of performing at least a portion of the activities. The computer-readable storage medium may include one or more programming instructions that, when executed, cause the computing device to partition the graph into a number of fragments that is greater than or equal to the number of identified groups. Each fragment may include one or more activities from the graph. The computer-readable storage medium may include one or more programming instructions that, when executed, cause the computing device to, for each fragment, transmit the fragment to an identified group that is capable of performing each activity associated with the fragment, and orchestrate the performance of the activities associated with each fragment by each group.

### BRIEF DESCRIPTION OF THE DRAWINGS

Aspects, features, benefits and advantages of the present invention will be apparent with regard to the following description and accompanying drawings, of which:

FIG. 1 illustrates a method of implementing a business process according to an embodiment.

FIG. 2 illustrates a business process execution system according to an embodiment.

FIG. 3 illustrates business process elements according to an embodiment.

FIG. 4A illustrates a pictorial representation of an “end join” construct according to an embodiment.

FIG. 4B illustrates a pictorial representation of a “branch indicator” construct according to an embodiment.

FIG. 4C illustrates a pictorial representation of a “conditional start” construct according to an embodiment.

FIGS. 5A and 5B illustrate a method of partitioning a business process definition according to an embodiment.

FIG. 6 illustrates an example of a business process definition according to an embodiment.

FIG. 7A-7C illustrate examples of fragments according to an embodiment.

FIG. 8 illustrates a block diagram of hardware that may be used to contain or implement program instructions according to an embodiment.

### DETAILED DESCRIPTION

The following terms shall have, for purposes of this application, the respective meanings set forth below:

An “activity” is a task that is part of a business process. Examples of activities in a print production environment may include printing, scanning, copying and the like.

A “business process” is a collection of activities or tasks that produce a specific service or product. A business process may be represented by a graph or other workflow. An example of a business process may include document management activities such as printing, binding, scanning, copying and the like.

A “fragment” is a portion of a business process. For example, a fragment may pertain to a portion of a graph representing a business process.

A “group” is a context for the execution of at least a portion of a business process. A group may include an entity, a department within an organization, a business process engine, a service provider and/or the like.

A “module” is a component of a larger system, such as a business process system. A module may include software, hardware or a combination of hardware and software.

To “orchestrate” means to coordinate one or more activities of one or more fragments of a business process.

To “partition” means to divide, separate or otherwise apportion one or more business processes into one or more fragments.

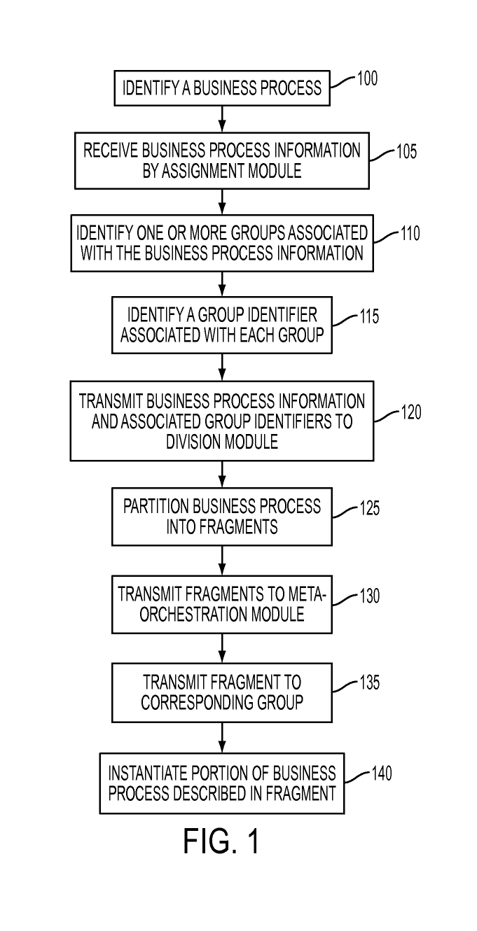

FIG. 1 illustrates a method of implementing a business process according to an embodiment. As illustrated by FIG. 1, a business process may be identified 100. A business process may include multiple activities or tasks that are performed to complete a process. In an embodiment, two or more of the activities or tasks may be performed by different groups, such as service providers, departments within an organization and/or the like. A business process system may utilize geographically separated groups to process portions of a single business process. For example, a business processed defined as a single workflow may be partitioned into multiple fragments, each of which may be executed independently by different distributed groups. The aggregated independent execution of the fragments by multiple groups may produce the same result as execution of the original workflow by a single business process engine.

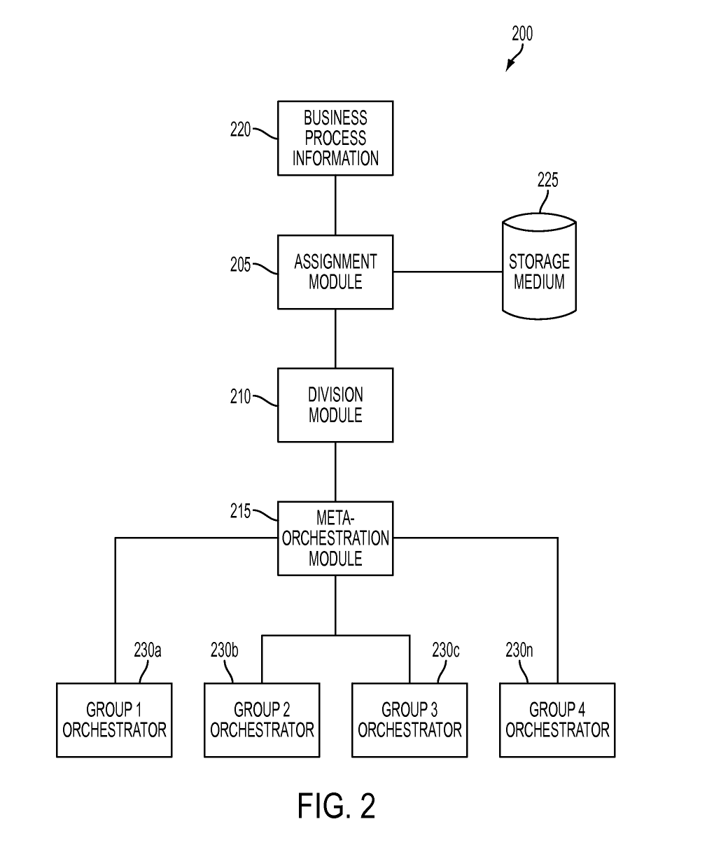

FIG. 2 depicts an illustrative business process execution system according to an embodiment. As illustrated by FIG. 2, a business process execution system 200 may include an assignment module 205, a division module 210 and/or a meta-orchestration module 215.

In an embodiment, an assignment module may receive 105 business process information 220. For example, an assignment module may receive 105 information from a computing device, a print device or other similar device. Business process information 220 may include a workflow associated with a business process, a graph representation of a workflow, information about one or more tasks or activities of the business process and/or the like. In an embodiment, business process information 220 may be included in a file, a script or another electronic format. For example, business process information 220 may be included in an XML file. Additional and/or alternate formats may be used within the scope of this disclosure.

In an embodiment, an assignment module may be in communication with a storage medium 225, such as a database or other computer-readable storage medium. The assignment module may be configured to store at least a portion of the received business process information 220 in the storage medium 225.

In an embodiment, the assignment module may identify 110 one or more groups associated with business process information. In an embodiment, certain activities of a business process may be performable by a single group. For example, scanning and printing may be performable by a single group. In an embodiment, hardware, software and/or a combination of hardware and software may be used by a group to process at least a portion of a business process.

In an embodiment, the assignment module may identify 115 a group identifier associated with each identified group. A group identifier may be a unique identifier associated with a group. In an embodiment, the assignment module may retrieve one or more group identifiers from its associated storage medium 225. In an embodiment, the assignment module may retrieve one or more group identifiers from another storage medium.

In an embodiment, the assignment module may transmit 120 the business process information and associated group identifiers to the division module. In an embodiment, the division module may partition 125 the business process into a plurality of fragments. Each fragment may be associated with a group. In an embodiment, a business process may be partitioned 125 into a number of fragments greater than or equal to a number of groups. In an embodiment, the division module may transmit 130 the plurality of fragments and the corresponding group identifiers to a meta-orchestration module. The meta-orchestration module may coordinate distribution of the fragments to their corresponding group. Table 1 illustrates examples of fragments and corresponding group identifiers according to an embodiment.

TABLE 1

| Group | 1 | 2 | 3 | 4 |
|---|---|---|---|---|
| Fragment | I | J | K | L |

In an embodiment, the meta-orchestration module may transmit 135 a fragment to its corresponding group. For example, as illustrated in Table 1, the meta-orchestration module may transmit 135 Fragment I to Group 1. Additional and/or alternate fragments, number of fragments, groups, number of groups and/or the like may be used within the scope of this disclosure.

In an embodiment, a group may include an orchestrator module 230a-n. An orchestrator module 230a-n may receive a fragment from the meta-orchestration module. In an embodiment, the orchestrator module for a group may instantiate 140 the portion of the business process described in the fragment. In an embodiment, the fragment having a start event that corresponds to the pre-division start event may proceed with its activities automatically. Other fragments may need to wait for a message or other input before beginning their activities. When an orchestration module encounters a message throw event, the orchestration module may use an attribute corresponding to the fragment to identify the group to which the payload of the message should be passed.

In an embodiment, a payload is one or more variables associated with a business process. In an embodiment, a payload may include one or more global process attributes. The global process attributes may be the same and/or similar to the attributes associated with the issuing fragment. In an embodiment, a payload may include data that is dependent on the type of the associated message. For example, payload data may differ depending on whether an associated message is an activity call message, an indicator message or a merge message.

In an embodiment, a fragment may not access all global process attributes associated with a payload. In an embodiment, not all objects generated by a fragment may be accessed by downstream fragments. As such, the size of a payload included in a message may be reduced in certain circumstances.

In an embodiment, a fragment graph data structure may be used. A fragment graph may be created by the meta-orchestration module when the meta-orchestration module distributes fragments to groups. The orchestration module for each group may receive a copy of the fragment graph from the meta-orchestration module. In an embodiment, the orchestration module for each group may store a copy of the fragment graph.

In an embodiment, the fragment graph may be a directed graph G(V,E), where V is the set of fragments. In an embodiment, E may be constructed as follows. If a fragment has a message throw event then for each fragment with a message catch event, cⁱⱼ, intended to be the recipient, an edge (fragment(mᵢ), fragment (cⁱⱼ)) may be added to E.

In an embodiment, the global attributes to add to a payload may be determined. In an embodiment, when a message throw event is going to be generated, a depth-first search may be started on the fragment graph using the fragment where the message throw event originates as a starting vertex for the search. The search criteria may include write access to an attribute by a fragment. Write access may be determined using a tag or other information associated with the business process definition for each fragment. For example, write access may be determined using the ioSpecification tag of the Business Process Modeling Notation (BPMN) for each fragment. BPMN is a graphical representation for defining a business process.

In an embodiment, when the search determines that there is downstream access to an attribute, the attribute may be added to the payload. In an embodiment, the depth-first search may be aborted if all attributes have been added to the payload. In an embodiment, the orchestration module for a group may notify the meta-orchestration module of one or more objects and/or process attributes that are not passed downstream. As such, the meta orchestration module may be able to retrieve required data from the appropriate location when all fragments have reached their respective end events. In an embodiment, determining which data objects to add to a payload may be accomplished using a similar method to that described above.

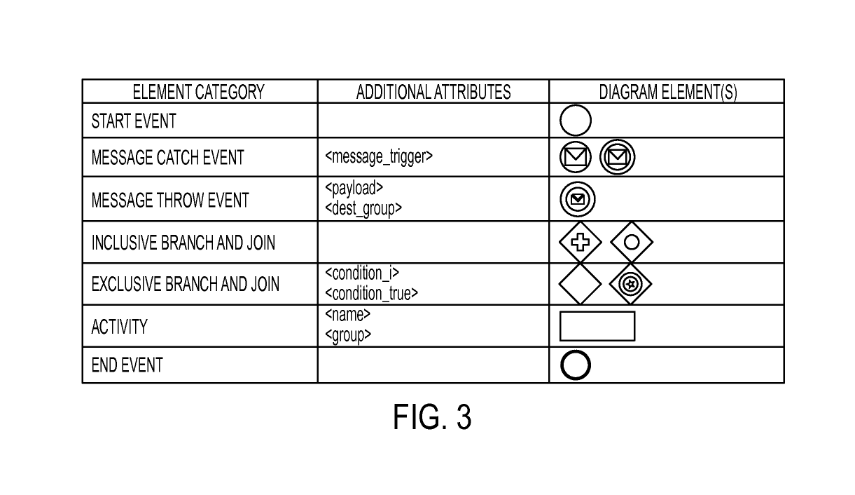

FIG. 3 illustrates examples of business process elements according to an embodiment. Although BPMN definitions and elements are described and used as examples in this disclosure, it is understood that additional and/or alternative business process definitions and/or elements may be used within the scope of this disclosure.

In an embodiment, a BPMN element may be parameterized by attributes, which may be denoted by angle brackets, and referenced programmatically with object attribute notation. In an embodiment, a BPMN element may have a category attribute, which may be denoted by <category>. A category attribute may correspond to the element type of the BPMN element. For example, as illustrated in FIG. 3, a start BPMN element may be associated with the category “start event.”

In an embodiment, a BPMN element may be associated with one or more outbound attributes which may reference sequences or data flows that may serve as a connector to another BPMN element. In an embodiment, an outbound attribute may be denoted by <next_i>.

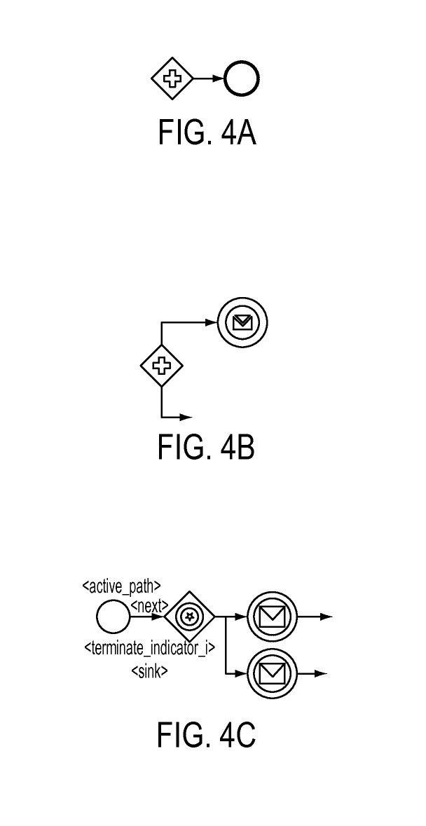

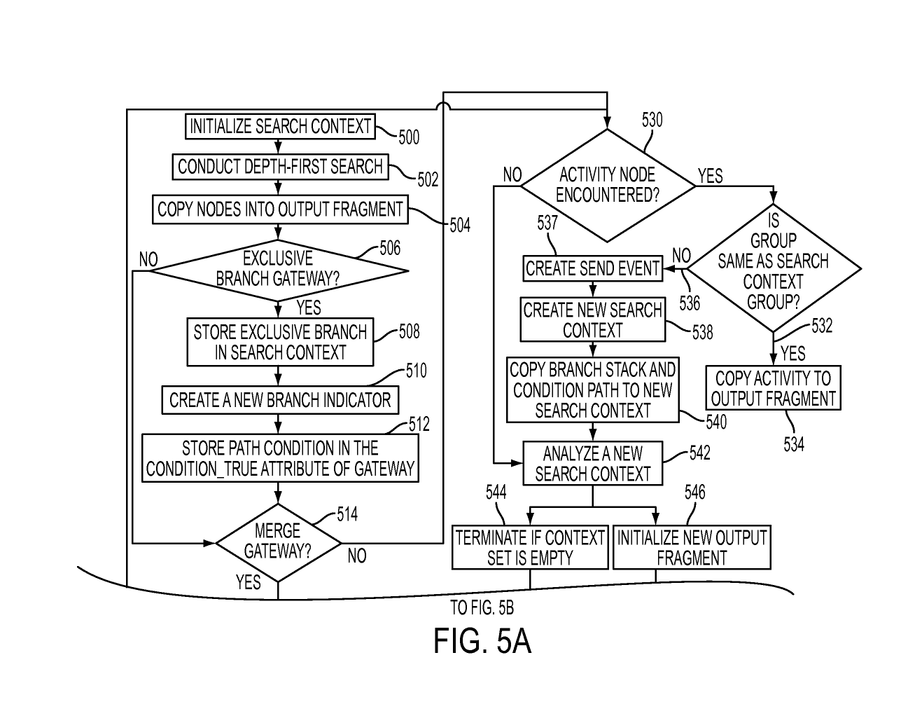

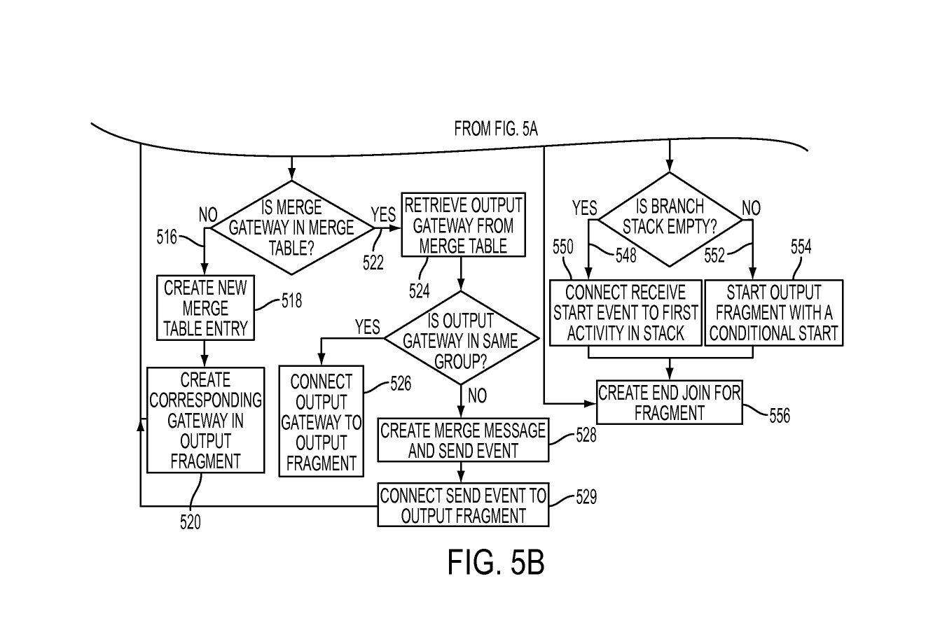

In an embodiment, a BPMN element may be a construct of one or more individual elements. Like an element, a construct may be parameterized by attributes. For example, FIG. 4A illustrates a pictorial representation of an “end join” construct. In an embodiment, an end join construct may correspond to a parallel join gateway that is connected to a none end event. An end join construct may be used as a sink for paths created for an output process fragment.

FIG. 4B illustrates a pictorial representation of a “branch indicator” construct. A branch indicator construct may correspond to a parallel branch gateway, and may be connected to an intermediate message throw event and to another element.

FIG. 4C illustrates a pictorial representation of a “conditional start” construct. A conditional start construct may correspond to a start event and may be followed by an event-based branch. Each event in the branch may be a message catch event. One of the events in the branch may trigger the execution of an activity. The remaining events may lead to an end join construct.

In an embodiment, specialized message types may be used to partition a business process definition. An activity call message, an indicator message and a merge message may be examples of specialized messages that may be used. In an embodiment, an activity message may represent an activity that does not belong to a group of a current fragment. An activity call message may include the activity name and parameters necessary to call the corresponding activity, as defined by the original business process definition.

In an embodiment, an indicator message may represent a choice that results from an exclusive conditional branch gateway. An indicator message may include the branch name and a condition corresponding to the path taken after the gateway.

In an embodiment, a merge message may represent a join gateway that is contained in a different fragment. A merge message may include a merge identifier and output of the previous activity or flow.

In an embodiment, a partitioning algorithm may use one or more specialized data structures. In an embodiment, a specialized data structure may include a search context. A search context may be described by the following:
Search context: {
   Start: BPMN node (depth-first search starting point)
   Group: current group number
   Branch_stack: stack of exclusive branch gateway nodes}

In an embodiment, a specialized data structure may include a merge table. In an embodiment, each entry in a merge table may include the following:
Input_gateway: join or merge gateway in input graph
Output_gateway: join or merge gateway in output graph fragment
Group: fragment group

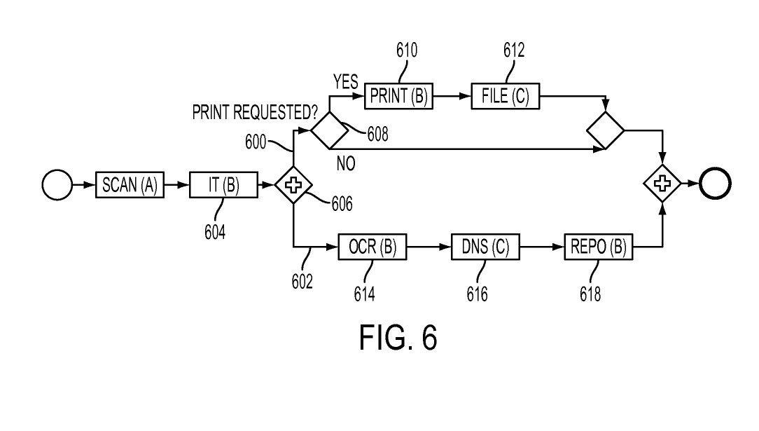

FIG. 5A and FIG. 5B illustrate a method of partitioning a business process definition according to an embodiment. In an embodiment, a partitioning method may receive as input a business process definition and, for each activity in the business process definition, a group number G. The output of the partitioning algorithm may include a plurality of business process fragments and, for each fragment, a group number G′ that corresponds to one of the input group numbers.

In an embodiment, two global structures may be maintained: a set of search contexts, each of which may represent a depth-first search from a different starting point in a business process definition graph, and an initially empty merge table. In an embodiment, a search context may be initialized 500 for each start event in a business process definition. In an embodiment, a depth-first search may be conducted 502 for each active search context. In an embodiment, one or more nodes from the business process definition may be copied 504 into an output fragment.

In an embodiment, different actions may be performed depending on the category of each node that is encountered in a search. In an embodiment, if an exclusive branch gateway is encountered 506, the branch may be stored 508 in the current search context, and a new branch indicator may be created 510 in the output fragment for each outgoing path from the branch. The message of the branch indicator may correspond to the branch name and condition of the path. This condition may be stored 512 in a condition_true attribute of the stored gateway.

In an embodiment, a merge or join gateway may be encountered 514. If the gateway does not exist in the merge table 516, a new merge table entry with a reference to the gateway may be created 518, and the corresponding gateway may be created 520 in the output fragment. In an embodiment, if a gateway already exists in the merge table 522, meaning that the gateway has already been traversed, then a corresponding output gateway may be retrieved 524 from the merge table. In an embodiment, the output gateway may be connected 526 directly to the output fragment if it is in the same group. In an embodiment, a merge message may be created 528 and a corresponding send event may be connected 529 to the output fragment of the current search context. In an embodiment, a catch event for the merge message may be connected with an incoming edge to the output gateway retrieved from the merge table. In an embodiment, a depth-first search may not continue downstream from a merge that has already been traversed. If the join is for an exclusive branch, it may be removed from the search context branch stack.

In an embodiment, an activity node may be encountered 530. If the group of the activity node is the same as the group of the current search context 532, the activity may be copied 534 to the output fragment and the depth-first search may continue. In an embodiment, if the group of the activity node is different than the group of the current search context 536, a send event with an activity call message may be created 537 in the output fragment with the activity name and group destination. A new search context may be created 538 starting with the activity for the new group. In an embodiment, the branch stack and condition path may be copied 540 to the new search context before the new search context is stored in the context set.

In an embodiment, when a depth-first search for each context finishes, the partitioning method may start analyzing 542 a new search context in the context set. In an embodiment, the partitioning method may terminate 544 if the context set is empty. For each new search context that is started, a new output fragment may be initialized 546. In an embodiment, if the branch stack of the search context is empty 548, a receive start event may be connected 550 to the first activity in the depth-first search stack (DFS stack). The message of the start event may correspond to the activity call message for that activity. In an embodiment, if the branch stack is not empty 552, then the output fragment may start 554 with a conditional start where the active path message corresponds to the first activity in the DFS stack. In an embodiment, each of the terminate indicator messages may correspond to the conditions of the branches in the branch stack that do not match the current path true condition. In an embodiment, an end join may be created 556 for the output fragment. The end join may be used as a sink for all finished branches.

In an embodiment, a partitioning method may be represented as follows:

```
Divide (Input_graph)
0 contexts = { }, merge_table = { }
1 For each start_event in Input_graph.start
2 Insert new SearchContext(start_event, “undefined”, { }) into
      contexts
3 For each search_context in contexts
4 Create new EndJoin end_join
5 If search_context.branch_stack is empty
6 If search_context.start == ‘Start event’
7 Create new StartEvent start_event
8 Else if search_context.start == ‘Activity’
9 Create new MessageCatchEvent start_event
10 start_event.message_trigger =
          search_context.start.name
11 start_event.next = copy(search_context.start)
12 DFS(search_context, search_context.start.next,
        start_event.next, end_join)
13 Else
14 Create new ConditionalStart cond_start
15 cond_start.active_path.message_trigger =
        search_context.branch_stack.top.condition_true
16 For each condition_i in search_context.branch_stack.top
17 If condition_i <>
          search_context.branch_stack.top.condition_true
18 cond_start.terminate_indicator_i.message_trigger =
            condition_i
19 cond_start.terminate_indicator_i.sink = end_join
20 End if
21 End for
22 cond_start.active_path.next = copy(search_context.start)
23 DFS(search_context, cond_start.active_path.next, end_join)
24 End if
25 End for
DFS(search_context, input_node, output_node, sink)
0 output_node.next = copy(input_node)
1 If input_node.category == ‘End event’
2 output_node.next = sink
3 Else if input_node.category == ‘Join gateway’
4 If input_node in merge_table.input_gateway
5 If merge_table.getOutputGW(input_node).group =
        input_node.group
6 output_node.next = merge_table.getOutputGW(input_node)
7 Else
8 Create new MessageThrowEvent to_merge
9 to_merge.payload = output_node.name
10 to_merge.dest_group =
          merge_table.getFragmentGroup(input_node)
11 to_merge.next = sink
12 End if
13 Else
14 Add input_node, output_node.next, search_context.group
        to merge_table
15 If input_node.category == ‘Exclusive join’
16 search_context.branch_stack.pop( )
17 End if
18 DFS(search_context, input_node.next, output_node.next, sink)
19 End if
20 Else if input_node.category == ‘Inclusive branch’
21 For each path in input_node.next
22 DFS(search_context, path, output_node.next, sink)
23 Else if input_node.category == ‘Exclusive branch’
24 search_context.branch_stack.push(input_node)
25 For each condition_i in input_node
26 input_node.condition_true = condition_i
27 Create new MessageThrowEvent condition_message
28 condition_message.payload = input_node.name(condition_i)
29 condition_message.dest_group = all
30 condition_message.next = sink
31 Create new BranchIndicator indicator
32 indicator.indicator_message = condition_message
33 output_node.next.next_i = indicator
34 DFS(search_context, input_node.next_i, indicator, sink)
35 End for
36 Search_context.branch_stack.pop( )
37 Else if input_node.category == ‘Activity’
38 If search_context.group == “undefined”
39 search_context.group = input_node.group
40 Else
41 If search_context.group <> input_node.group
42 Insert new SearchContext(input_node, input_node.group,
          search_context.branch_stack) into contexts
43 Create new MessageThrowEvent activity_call
44 activity_call.payload = input_node.name
45 activity_call.dest_group = input_node.group
46 activity_call.next = sink
47 output_node.next = activity_call
48 Else
49 DFS(search_context, input_node.next, output_node, sink)
50 End if
51 End if
52 End if
```

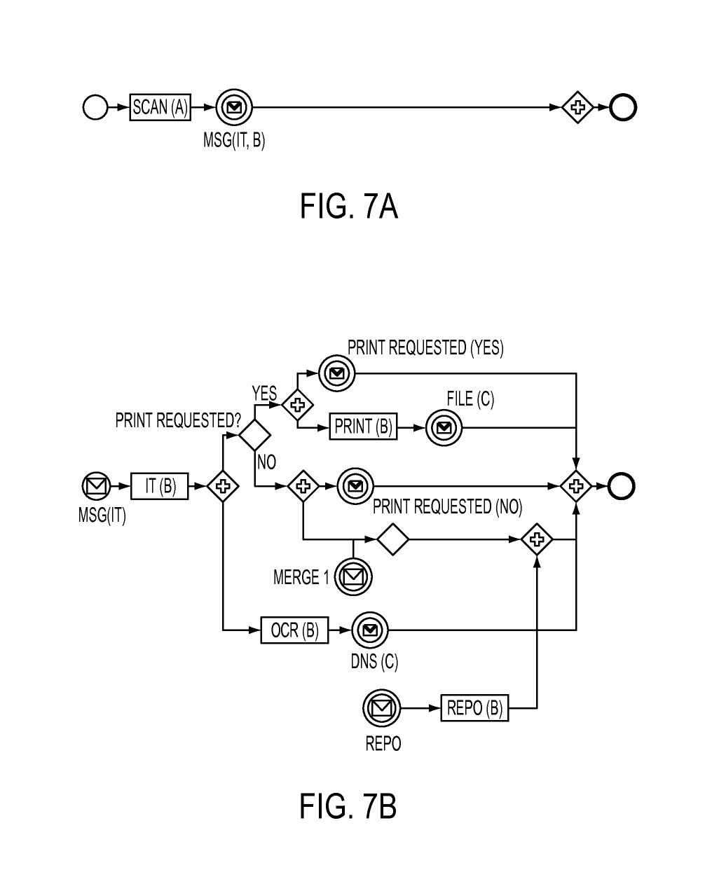

FIG. 6 illustrates a business process definition according to an embodiment. As illustrated by FIG. 6, the business process definition includes activities for three groupings, namely groups A, B and C. As such, the business process definition illustrated in FIG. 6 may be partitioned into three or more fragments. For example, the business process definition may be partitioned into fragments using the partitioning method described above.

The example business process depicted in FIG. 6 illustrates a document processing method in which a document may be scanned, enhanced, processed, stored and optionally, printed. As illustrated by FIG. 6, two branches 600, 602 may proceed in parallel after the image enhancement step 604, as denoted by the parallel gateway 606. One branch 600 is optional, as denoted by the exclusive gateway 608. This branch 600 may include printing 610 and manual filing 612 activities. The other branch 602 is always performed, and contains an optical character recognition activity 614, a document naming activity 616 and a repository service activity 618 to store digitized content.

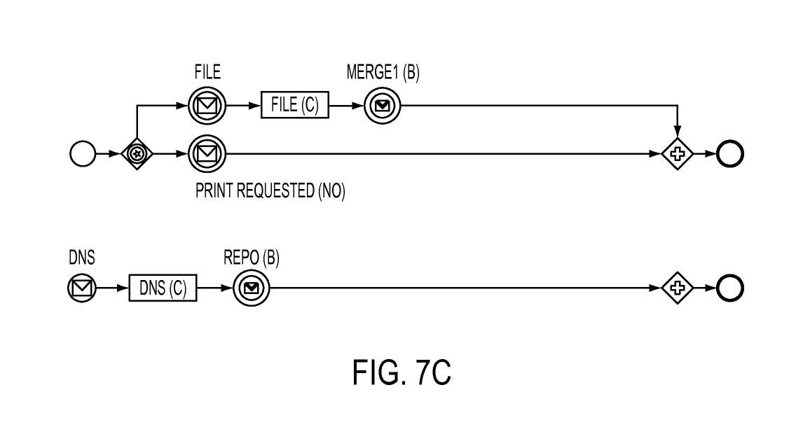

FIG. 7A illustrates a fragment that may be generated to be processed by Group A. FIG. 7B illustrates a fragment that may be generated and processed by Group B. FIG. 7C illustrates a fragment that may be generated and processed by Group C.

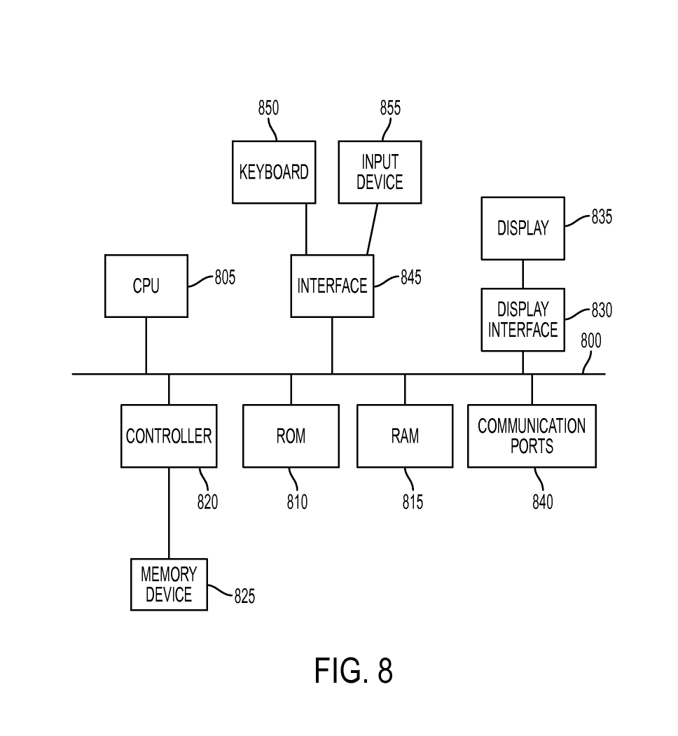

FIG. 8 depicts a block diagram of hardware that may be used to contain or implement program instructions according to an embodiment. A bus 800 serves as the main information highway interconnecting the other illustrated components of the hardware. CPU 805 is the central processing unit of the system, performing calculations and logic operations required to execute a program. Read only memory (ROM) 810 and random access memory (RAM) 815 constitute examples of memory devices.

A controller 820 interfaces with one or more optional memory devices 825 to the system bus 800. These memory devices 825 may include, for example, an external or internal DVD drive, a CD ROM drive, a hard drive, flash memory, a USB drive or the like. As indicated previously, these various drives and controllers are optional devices.

Program instructions may be stored in the ROM 810 and/or the RAM 815. Optionally, program instructions may be stored on a tangible computer readable storage medium such as a hard disk, compact disk, a digital disk, flash memory, a memory card, a USB drive, an optical disc storage medium, such as Blu-ray™ disc, and/or other recording medium.

An optional display interface 830 may permit information from the bus 800 to be displayed on the display 835 in audio, visual, graphic or alphanumeric format. Communication with external devices may occur using various communication ports 840. A communication port 840 may be attached to a communications network, such as the Internet or an intranet.

The hardware may also include an interface 845 which allows for receipt of data from input devices such as a keyboard 850 or other input device 855 such as a mouse, a joystick, a touch screen, a remote control, a pointing device, a video input device and/or an audio input device.

An embedded system, such as a sub-system within a xerographic apparatus, may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of implementing a business process, the method comprising:
receiving business process information associated with a business process, wherein the business process information comprises a graph representing one or more activities to be performed to complete the business process;
identifying, by a computing device, a number of groups associated with the business process information, wherein each group is capable of performing at least a portion of the activities;
partitioning, by the computing device, the graph into a number of fragments that is greater than or equal to the number of identified groups, wherein each fragment comprises one or more activities from the graph;
for each fragment, transmitting the fragment to an identified group that is capable of performing each activity associated with the fragment; and
orchestrating the performance of the activities associated with each fragment by each group.

2. The method of claim 1, wherein the business process information is represented in Business Process Model and Notation.

3. The method of claim 1, wherein partitioning the graph comprises:
identifying a start event from the graph;
creating a start context associated with the start event; and
performing a depth-first search of the graph beginning at the start event by:
determining whether an exclusive branch gateway is encountered,
in response to an exclusive branch gateway being encountered:
storing an associated exclusive branch in the start context, and
adding a branch indicator to an output fragment for each outgoing path from the exclusive branch.

4. The method of claim 1, wherein partitioning the graph comprises:
identifying a start event from the graph; and
performing a depth-first search of the graph beginning at the start event by:
determining whether a merge gateway is encountered, and
in response to a merge gateway being encountered:
determining whether the merge gateway is listed in a merge table,
in response to the merge gateway not being listed in a merge table, creating an entry in the merge table that references the merge gateway, and
adding the merge gateway to an output fragment.

5. The method of claim 1, wherein partitioning the graph comprises:
identifying a start event from the graph; and
performing a depth-first search of the graph beginning at the start event by:
determining whether a merge gateway is encountered, and
in response to a merge gateway being encountered:
determining whether the merge gateway is listed in a merge table,
in response to the merge gateway being listed in a merge table:
retrieving an output gateway from the merge table,
determining whether the output gateway is associated with a same group as the merge gateway,
in response to the output gateway being associated with the same group as the merge gateway, adding the output gateway to an output fragment, and
in response to the output gateway not being associated with the same group as the merge gateway:
creating a merge message and an associated send event,
connecting the send event to the output fragment,
creating a corresponding catch event associated with the merge message, and
connecting it with an incoming edge to the output gateway.

6. The method of claim 1, wherein partitioning the graph comprises:
identifying a search context comprising a start event from the graph and an indication of a current group; and
performing a depth-first search of the graph beginning at the start event by:
determining whether an activity node is encountered, wherein the activity node is associated with an activity, and
in response to an activity node being encountered:
determining whether a group associated with the activity node is the same as the current group,
in response to the group associated with the activity node being the same as the current group, adding the activity to an output fragment, and
in response to the group associated with the activity node not being the same as the current group:
adding a send event having an activity call message to the output fragment, wherein the activity call message comprises a name of the activity and a group associated with the activity node, and
creating a second search context comprising a second start event associated with the activity node.

7. The method of claim 1, wherein orchestrating the performance of the activities associated with each fragment by each group comprises transferring one or more of the following between groups:
an activity call message;
an indicator message; and
a merge message.

8. A system for implementing a business process, the system comprising:
a computing device; and
a computer-readable storage medium in communication with the computing device, wherein the computer-readable storage medium comprises one or more programming instructions that, when executed, cause the computing device to:
receive business process information associated with a business process, wherein the business process information comprises a graph representing one or more activities to be performed to complete the business process,
identify a number of groups associated with the business process information, wherein each group is capable of performing at least a portion of the activities,
partition the graph into a number of fragments that is greater than or equal to equal to the number of identified groups, wherein each fragment comprises one or more activities from the graph,
for each fragment, transmit the fragment to an identified group that is capable of performing each activity associated with the fragment, and
orchestrate the performance of the activities associated with each fragment by each group.

9. The system of claim 8, wherein the business process information is represented in Business Process Model and Notation.

10. The system of claim 8, wherein the one or more programming instructions that, when executed, cause the computing device to partition the graph comprise one or more programming instructions that, when executed, cause the computing device to:
identify a start event from the graph,
create a start context associated with the start event, and
perform a depth-first search of the graph beginning at the start event by:
determining whether an exclusive branch gateway is encountered,
in response to an exclusive branch gateway being encountered:
storing an associated exclusive branch in the start context, and
adding a branch indicator to an output fragment for each outgoing path from the exclusive branch.

11. The system of claim 8, wherein the one or more programming instructions that, when executed, cause the computing device to partition the graph comprise one or more programming instructions that, when executed, cause the computing device to:
identify a start event from the graph; and
perform a depth-first search of the graph beginning at the start event by:
determining whether a merge gateway is encountered, and
in response to a merge gateway being encountered:
determining whether the merge gateway is listed in a merge table,
in response to the merge gateway not being listed in a merge table, creating an entry in the merge table that references the merge gateway, and
adding the merge gateway to an output fragment.

12. The system of claim 8, wherein the one or more programming instructions that, when executed, cause the computing device to partition the graph comprise one or more programming instructions that, when executed, cause the computing device to:
identify a start event from the graph; and
perform a depth-first search of the graph beginning at the start event by:
determining whether a merge gateway is encountered, and
in response to a merge gateway being encountered:
determining whether the merge gateway is listed in a merge table,
in response to the merge gateway being listed in a merge table:
retrieving an output gateway from the merge table,
determining whether the output gateway is associated with a same group as the merge gateway,
in response to the output gateway being associated with the same group as the merge gateway, adding the output gateway to an output fragment, and
in response to the output gateway not being associated with the same group as the merge gateway:
creating a merge message and an associated send event,
connecting the send event to the output fragment,
creating a corresponding catch event associated with the merge message, and
connecting it with an incoming edge to the output gateway.

13. The system of claim 8, wherein the one or more programming instructions that, when executed, cause the computing device to partition the graph comprise one or more programming instructions that, when executed, cause the computing device to:
identify a search context comprising a start event from the graph and an indication of a current group; and
perform a depth-first search of the graph beginning at the start event by:
determining whether an activity node is encountered, wherein the activity node is associated with an activity, and
in response to an activity node being encountered:
determining whether a group associated with the activity node is the same as the current group,
in response to the group associated with the activity node being the same as the current group, adding the activity to an output fragment, and
in response to the group associated with the activity node not being the same as the current group:
adding a send event having an activity call message to the output fragment, wherein the activity call message comprises a name of the activity and a group associated with the activity node, and
creating a second search context comprising a second start event associated with the activity node.

14. The system of claim 8, wherein the one or more programming instructions that, when executed, cause the computing device to orchestrate the performance of the activities associated with each fragment by each group comprise one or more programming instructions that, when executed, cause the computing device to transfer one or more of the following between groups:
an activity call message;
an indicator message; and
a merge message.
